(19) United States
(12) Patent Application Publication
(10) Pub. No.: US 2014/0285347 A1
(43) Pub. Date: Sep. 25, 2014

(54) Sound and Illumination System for a Handbag

(71) Applicants: Timothy A. Kearns, Emporia, KS (US); Steven A. Tobenkin, Las Vegas, NV (US)

(72) Inventors: Timothy A. Kearns, Emporia, KS (US); Steven A. Tobenkin, Las Vegas, NV (US)

(21) Appl. No.: 14/219,741

(22) Filed: Mar. 19, 2014

Related U.S. Application Data
(60) Provisional application No. 61/803,282, filed on Mar. 19, 2013.

(51) Int. Cl. H01H 9/16

(52) U.S. Cl. CPC H01H 9/167
USPC 340/644

(57) ABSTRACT

A sound and illumination system for a handbag is provided. The handbag includes at least one wall defining an opening and an interior compartment that is accessible therethrough. The opening is configured for being selectively placed in an opened position to allow access to the interior compartment. The system comprises a sound module configured for emitting sound upon activation of the sound module, the sound being generated based upon an audio file stored in a memory. An illumination module is configured for emitting light upon activation of the illumination module, the light being emitted based upon a light emission file stored in the memory. A mounting system is configured for attaching the sound and illumination modules with the wall of the handbag. A switch mechanism is configured for selectively activating the sound and illumination modules to emit light and sound within the interior compartment of the handbag.

### CROSS-REFERENCE TO RELATED APPLICATIONS

This application claims the benefit of U.S. Patent Application No. 61/803,282, filed Mar. 19, 2013, which is hereby incorporated by reference in its entirety.

### FIELD OF THE INVENTION

The present invention is generally directed to a sound and illumination system for a handbag, purse, totable, or the like (hereinafter “handbag”); in particular, the system includes an enclosure that is positioned within the handbag and configured for emitting both light and sound within the handbag at the same time, wherein the emission of light and sound is configurable by a user using an external computing device.

### BACKGROUND OF THE INVENTION

The use of handbags, purses, totables, and the like are commonplace throughout the world. Handbags may be used for many different purposes. For example, a handbag may be used to carry money, valuables, make-up, and other personal items that may be needed by an individual. Handbags may also be used for fashion reasons, wherein different handbags are used for certain seasons. But for the most part, existing handbags are used for utilitarian reasons.

When looking inside a handbag, it is sometimes difficult to locate items placed therein because there is a limited amount of light that is permitted to enter the interior compartment of the handbag. This sometimes causes delays and frustration when searching for items, particularly smaller items. To address this problem, a light may be used to light up a limited portion of the interior compartment. However, even with the use of a light within the interior compartment, it is not always easy to locate items within the handbag, thereby reducing a user's experience when looking within the handbag.

As such, there is a need for a system that provides both light and sound within an interior compartment of a handbag to create a better user experience. There also exists a need for a system that allows the light and sound emitted within the handbag to be configurable by the user of the handbag. The present invention addresses these and other needs.

### SUMMARY OF THE INVENTION

In accordance with one embodiment, to address the above-referenced drawbacks of the existing art, the present invention provides a sound and illumination system for an enclosure, such as, for example, handbag, purse, briefcase, beach bag, or totable (“handbag”). The handbag includes at least one wall defining an enclosure opening and an interior compartment that is accessible through the enclosure opening. The enclosure opening is configured for being selectively placed in an opened position to allow access to the interior compartment and a closed position to restrict access to the interior compartment. The system may comprise a memory; a sound module configured for emitting sound upon activation of the sound module, the sound being generated based upon an audio file stored in the memory; an illumination module configured for emitting light upon activation of the illumination module, the light being emitted based upon a light emission file stored in the memory; a mounting system configured for attaching the sound module and illumination module with the at least one wall of the enclosure within the interior compartment; and a switch mechanism configured for selectively activating the sound and illumination modules to emit light and sound within the interior compartment of the enclosure when in the opened position.

In further aspect, the system may further include a communication module configured for allowing at least one of the sound file and the light emission file to be downloaded into the sound and illumination system memory from an external computing device. The external computing device may be in communication with the sound and illumination system memory through a network or through synchronization via BLUETOOTH, ZIGBEE or other similar technologies. Further, the external computing device may be programmed to include a software application configured to access a remote server, download the at least one sound and the light emission file from the server, and store the at least one sound or light emission file in a memory of the external computing device. Further, the communication module may be configured for allowing at least one of the sound file and the light emission file to be downloaded into the sound and illumination system memory from the remote server. The system may also include a data transfer port configured for allowing at least one of the sound file and the light emission file to be downloaded into the memory from an external computing device.

In another aspect of the invention, a method of providing sound and illumination within an enclosure is provided, wherein the enclosure includes at least one wall defining an enclosure opening and an interior compartment that is accessible through the enclosure opening, and the enclosure opening configured for being selectively placed in an opened position to allow access to the interior compartment and a closed position to restrict access to the interior compartment. The method may comprise providing a sound module configured for emitting sound upon activation of the sound module; providing an illumination module configured for emitting light upon activation of the illumination module; allowing the sound and illumination modules to be coupled to the at least one wall of the enclosure within the interior compartment; and selectively allowing the sound and illumination modules to emit sound and light within the interior compartment of the enclosure when in the opened position.

In another aspect, the method may further provide a first memory and a communication module, wherein the communication module is configured for allowing at least one of a sound file and/or a light emission file to be downloaded into the first memory, and wherein the sound emitted is based upon the sound file stored in the first memory and the light emitted is based upon the light emission file stored in the first memory. Further, an external computing device may include a second memory and a software application stored in the second memory, wherein the software application is configured to access a remote server and download the sound file and/or light emission file from the server and store the sound file and/or light emission file in the second memory. The sound file and/or light emission file may be downloaded into the first memory from the external computing device through a wired connection, a wireless network connection, or through synchronization via BLUETOOTH, ZIGBEE or other similar technologies. The external computing device is configured for automatically emitting a trigger signal to the communication module upon recognizing a triggering event, wherein the triggering signal is received by the communication module so that the sound module and/or illumination module is activated. Further, the external computing device is configured for emitting a manual trigger signal to the communication module, wherein the manual trigger signal is received by the communication module so that the sound module and/or illumination module is activated.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a schematic drawing of a sound and illumination system for a handbag in accordance with the present invention;

FIG. 2 is a schematic drawing generally illustrating a computing environment in which the invention may be implemented;

FIG. 3 is a photograph of a handbag that may be used with the present invention; and

FIG. 4 is a photograph of the handbag illustrated in FIG. 3 showing the system of the present invention positioned within the handbag.

### DETAILED DESCRIPTION OF THE INVENTION

Generally, the tools and methods described herein for providing sound and illumination within an interior compartment of an enclosure, such as, for example, handbag, purse, or totable, may be implemented in hardware, software or a combination thereof.

This document provides and describes an overview of an exemplary environment and implementation of the present invention. An exemplary computer environment for the implementation and use of the invention is also presented and described.

In general, the present invention provides a system and method for providing sound and illumination within an interior compartment of an enclosure when the enclosure is opened and/or accessed by a user. The sound and illumination provided by the system and method may either be preloaded or selected by a user to not only make it easier to view the contents within the interior compartment, but also provide a customized and personalized user experience when accessing the interior compartment of the enclosure. It should be understood that the enclosure may be any type of bag, purse, handbag, briefcase, beach bag, totable, or apparatus that is used to carry items within an interior compartment of the enclosure (referred to herein as a “handbag”). In using the system and method of the present invention, the handbag would be opened and the user's favorite song, audio file or partial audio file would play and one or more lights would come on in the colors, sequence, and longevity as determined by the user, thereby creating a disco-like effect inside the handbag. The system and method could also be used as an alarm for a handbag to emit sound and light to alert the user of unauthorized entry into the handbag.

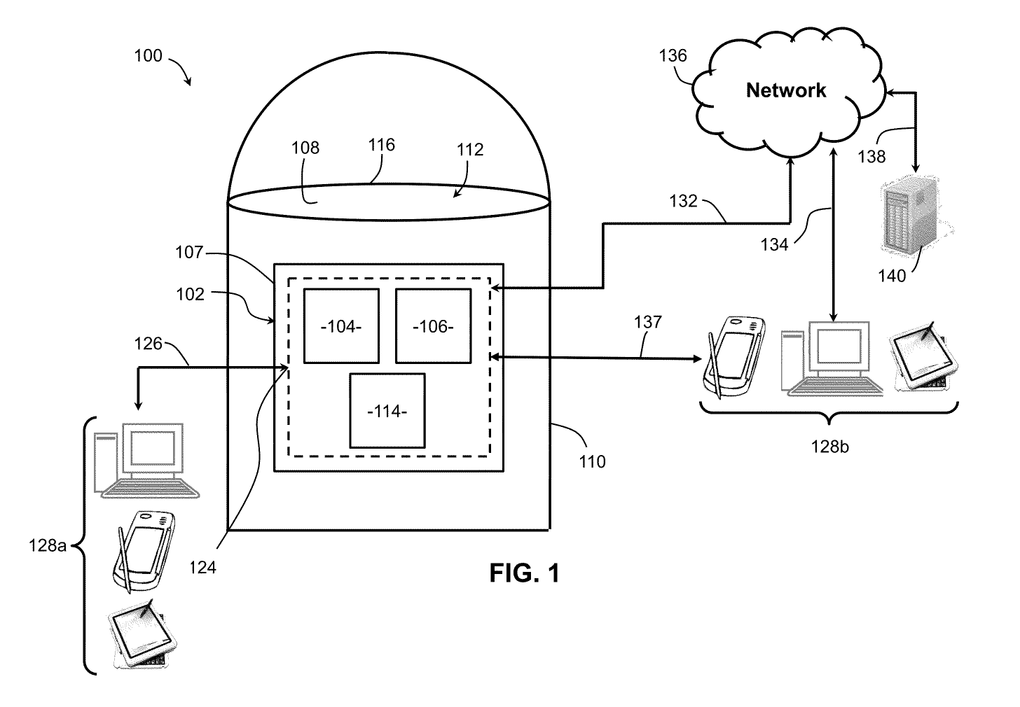

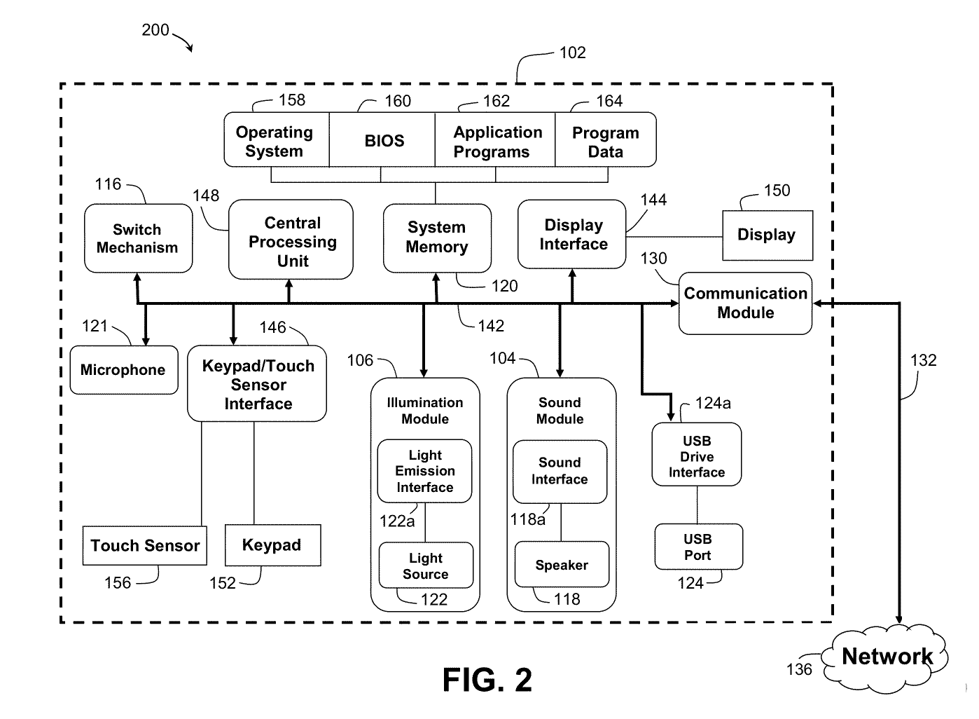

Referring to the drawings in detail, and specifically to FIGS. 1-2, a sound and illumination system according to one aspect of the present invention is generally designated as reference numeral 100. System 100 comprises a sound/illumination device 102 including a sound module 104 and an illumination module 106 disposed within a housing 107. Housing 107 may include a mounting system for removably attaching sound/illumination device 102 to a wall 108 of a handbag 110, such as, but not limited to, adhesive, hook and loop fastener, or a mechanical fastener. Further, housing 107 may be configured to allow for an outer faceplate to be selectively removed and replaced allowing a user to change the look and feel of sound/illumination device 102. Instead of providing a mounting system that allows sound/illumination device 102 to be removably attached to wall 108 of handbag 110, housing 107 may be integrally attached or formed within wall 108 of handbag 110. The mounting system may also include a pivot mechanism for adjusting the position of the sound/illumination device 102 within an interior compartment 112 of handbag 110.

The sound/illumination device 102 may further include a switch mechanism 114 configured for selectively activating the sound and illumination modules 104, 106 to emit light and sound within interior compartment 112 when an opening 116 of handbag 110 is in an opened position. In one aspect of the invention, switch mechanism 114 may be a mechanical switch, for example, a simple mechanical on/off switch or a switch integrated with a zipper that is used to selectively maintain opening 116 in a closed position. A photovoltaic cell or touch/heat sensor could also be used to activate the sound and illumination modules 104, 106 when handbag 110 is opened. In another aspect of the invention, switch mechanism 114 may activate sound and illumination modules 104, 106 when a motion sensor senses motion within interior compartment 112.

Sound module 104 is configured for emitting sound from a speaker 118 upon activation of sound module 104 by switch mechanism 114, wherein the sound is generated based upon an audio file stored in a memory 120 of device 102. For example, a portion of device 102 and/or sound module 104 may be a MP3 player. Further, the sound file may be a full song, part of a song, or an audio file generated by a user. For example, the audio file may be generated by a user by speaking into a microphone 121 provided in device 102, wherein the generated audio file is stored in memory 120 and may be used to selectively play back the words or sounds spoken by the user using speaker 118.

Illumination module 106 is configured for emitting light from one or more lights 122 upon activation of illumination module 106 by switch mechanism 114, wherein the light being emitted is based upon a light emission file stored in memory 120. In one aspect of the invention, lights 122 may be an interchangeable array of lights, which may be one color or multi-colored, light emitting diodes (LED), and/or fiber optics.

Further, sound/illumination device 102 may include a power source to provide the necessary power for all of the components, including sound and illumination modules 104, 106, through battery power or the like. Illumination module 106 is configured for emitting lights in any sequence of color, timing, and/or duration of time to provide for a customized light emission pattern. It should be understood that the audio and light emission files may be independent of one another so that the sound emitted from sound module 104 does not coincide with the light being emitted from illumination module 106. In another aspect of the invention, audio and light emission files may be separate files synchronized together so that when sound is emitted from sound module 104, such as a song, light is emitted by illumination module 106 in a manner that coincides with the notes of the song to provide an enhanced experience within interior compartment 112 when handbag 110 is opened. It should be understood that the desired sound and light emission may be represented in a single file and perform the same operation. It should be understood that anywhere in the description where the sound and light emission files are described as being separate files, it should be understood that this also means that the two files can be represented as a single data file including information related to both sound and light emission.

In another aspect of the present invention, the sound and light emission files may be provided in memory 120 of sound/illumination device 102 in a number of different ways. For instance, sound/illumination device 102 may include a data transfer port, such as a USB port 124, to allow the sound and light emission files to be communicated 126 to memory 120 from an external computing device 128a, such as, for example, a smart phone, desktop computer, laptop, tablet, and the like. In another aspect, sound/illumination device 102 may include a communication module 130 to allow the sound and light emission files to be communicated 132, 134 to memory 120 from an external computing device 128b through a network 136, such as the Internet, or in instances where external computing device 128b is a smart phone, tablet or the like, through wireless synchronization 137, such as through BLUETOOTH, ZIGBEE or other similar technologies.

Communication module 130 may also be used to download sound and light emission files to memory 120 by communication 138 with a server 140 through network 136, which stores and provides access to such files. Server 140 may include a data store that provides free access to sound and light emission files stored therein, or may provide a subscription-based user interface that allows sound and light emission files to be downloaded for a one-time or periodic fee. It should be understood that communication module 130 may provide for wireless communication with one or more external computing devices 128b through network 136.

Additionally, external computing device 128b, when embodied by a wireless handheld device, such as a smart phone, tablet or the like, may include a software application (“app”) stored in a memory of external computing device 128b. The app is programmed and configured to program, configure, edit or otherwise customize sound and/or light emission files that are stored in external computing device 128b, which will be subsequently communicated to sound/illumination device 102. For example, the app may be configured to select a portion of sound and/or light emission file for execution when initiated by switch mechanism 114, select the amount of time that the sound and/or light will play for after initiated by switch mechanism 114, or select the color of light, number of colors, light intensity, or light patterns to be emitted after initiated by switch mechanism 114. The app may be preloaded in the memory of external computing device 128b, or may be downloaded from server 140 via network 136. The app may be configured to allow external computing device 128b to download sound and/or light emission files stored on server 140 to the memory of external computing device 128b. These downloaded files may then be programmed, configured, edited or otherwise customized as described herein, or simply transferred to sound/illumination device 102 without modification. Using the app, a user may disseminate one or more sound and/or light emission files to one or more multiple sound/illumination devices 102. This may be of particular advantage when access to server 140 requires a subscription or other associated service fee.

In yet another example, sound and light emission files may be preloaded in memory 120 so that the user does not need to perform any downloading using external computing devices 128a, 128b, or server 140.

FIG. 2 shows an exemplary computing environment 200 that can be used to implement any of the processing thus far described with respect to sound/illumination device 102, some of the components of computing environment 200 having already been described above. Computer 200 is adapted to be associated with handbag 110 as described above, and may include a system bus 142 that couples a display interface 144, communication module 130, a keypad/touch sensor interface 146, and system memory 120 to a Central Processing Unit (CPU) 148. A monitor or display screen 150 is connected to bus 142 by display interface 144 and provides the user with a graphical user interface to view information related to the sound and/or light emission files stored in memory 120. The graphical user interface allows the user to enter commands and information into computer 200 using a keypad 152 and a user interface selection device, such as a touch sensor 156. Keypad 152 and user interface selection device 156 are connected to bus 142 through keypad/touch sensor interface 146. The display 150 and user interface selection device 156 are used in combination to form the graphical user interface which allows the user to implement at least a portion of the present invention, by providing the ability to view and select sound and light emission files. Other peripheral devices, such as computing device 128a, may be connected to computer 200 through universal serial bus (USB) port 124 to transfer sound and light emission files to and from computer 200.

The system memory 120 is also connected to bus 142 and may include read only memory (ROM), random access memory (RAM), an operating system 158, a basic input/output system (BIOS) 160, one or more application programs 162 and program data 164. Memory 120 may further include a hard disk drive for reading from and writing to a hard disk. The computer 200 may also include USB drive 124 and other types of drives for reading from and writing to flash memory devices (e.g., compact flash, memory stick/PRO and DUO, SD card, multimedia card, smart media xD card). A USB drive interface 124a operates to connect bus 142 to USB port 124. Further, sound module 104 includes a sound interface 118a, and illumination module 106 includes a light emission interface 122a, that operate to connect bus 142 to speaker 118 and light source 122. Each of these interfaces and their associated computer-readable media may provide computer 200 with non-volatile storage of computer-readable instruction, program modules, data structures, application programs, an operating system, and other data for the computer 200. In addition, it will be understood that computer 200 may also utilize other types of computer-readable media in addition to those types set forth herein, such as digital video disks, random access memory, read only memory, other types of flash memory cards, and the like.

As mentioned above, computer 200 may operate in a networked environment using logical connections with computing device 128b and server 140. Communication module 130 provides communication path 132 between bus 142 and network 136, which allows sound and light emission files to be communicated through network 136 from computing device 128b and server 140. This type of logical network connection is commonly used in conjunction with a local area network (LAN). However, it will be appreciated that the network connections shown herein are merely exemplary, and it is within the scope of the present invention to use other types of network connections between computer 200 and computing device 128b and server 140 including both wired and wireless connections, as well as wide area networked connections (WAN).

As described above, system 100 may comprise external computing device 128b, such as a smart phone, tablet or other similar wireless handheld computing device, that includes an app configured to download selected sound and/or light emission files from server 140 via network 136 and store such files within the memory of external computing device 128b. Using the app, a user may program, configure, edit or otherwise customize the stored sound and/or light emission files or simply save the downloaded files to memory. The stored files may then be selectively transferred from external computing device 128b to memory 120 of sound/illumination device 102 through a wired (e.g., USB), wireless (e.g., over a network) communication, or through synchronization via BLUETOOTH, ZIGBEE or other similar technologies. In this manner, the app allows external computing device 128b to customize the color, intensity, patterns and/or music/sounds emitted by device 102, and allows for numerous changes throughout the day to adjust the sound/light outputs to coincide with the user's mood, attire or environment, such as, but not limited to, a movie theater, sporting event or concert and the like). By way of example, if a user is attending a college sporting event, he or she could download his or her alma mater's fight song from the wireless computing device 128b to the sound/illumination device 102 so that each time the handbag is opened, the system plays the school's song synchronized with the school's colors.

In another aspect of the present invention, external computing device 128b (and loaded app) may be synchronized with the communication module 130 so that sound module 104 and/or illumination module 106 may be automatically triggered upon an app-recognized triggering event. To continue the college sporting event example, the user may program the app to communicate a trigger signal to communication module 130 of device 102 upon the occurrence of one or more specific events that are recognizable by the app. Upon receipt of the trigger signal, communication module 130 will then communicate with switch mechanism 114 to activate sound module 104 and/or illumination module 106. For instance, the school's song and/or colors may be activated upon the team's scoring of a touchdown or field goal. In this example, the app may be in communication with the venue's public address system or the Internet, so that a score is communicated to external computing device 128b (e.g., smart phone), which in turn communicates with the sound/illumination device 102 to trigger activation of sound module 104 and/or illumination module 106. In a further aspect, the app and sound/illumination device 102 may be coordinated such that more than one sound and/or visual display may be selectively triggered depending upon the species of the triggering event. For example, a first sound and/or light display may be triggered upon a positive event (e.g., scoring a touchdown) while a second sound and/or light display may be triggered upon a negative event (e.g., being scored against). In this manner, sound/illumination device 102 can enrich a user's game experience.

In another aspect of the present invention, with external computing device 128b (such as a smart phone or tablet) synchronized with sound/illumination device 102 via, for instance, BLUETOOTH or ZIGBEE, external computing device 128b may be used as a manual trigger. That is, a user may manually initiate a triggering event by pressing/touching one or more keys or buttons on external computing device 128b thereby causing communication module 130 to receive a signal indicative of the key that was pressed, and activate the appropriate sound and/or light emitting files. As an example, this situation may be beneficial should a user misplace his or her handbag in a crowded room, restaurant or movie theater. To locate the missing article, a user could use his or her cell phone to ping communication module 130 thereby causing activation of the audio and/or visual display which, hopefully, leads to the bag's discovery.

In accordance with the above, the present invention generally provides a method of providing sound and illumination within an enclosure. The enclosure includes at least one wall defining an enclosure opening and an interior compartment that is accessible through the enclosure opening. The enclosure opening is configured for being selectively placed in an opened position to allow access to the interior compartment and a closed position to restrict access to the interior compartment. The method generally comprises the steps of providing a sound module configured for emitting sound upon activation of the sound module; providing an illumination module configured for emitting light upon activation of the illumination module; allowing the sound and illumination modules to be coupled to the at least one wall of the enclosure within the interior compartment; and selectively allowing the sound and illumination modules to emit sound and light within the interior compartment of the enclosure when in the opened position. In one aspect, the sound and light emitted within the interior compartment may be synchronized. Further, the sound module and illumination modules may be configured for emitting sound and light within the interior compartment when motion is sensed within the interior compartment.

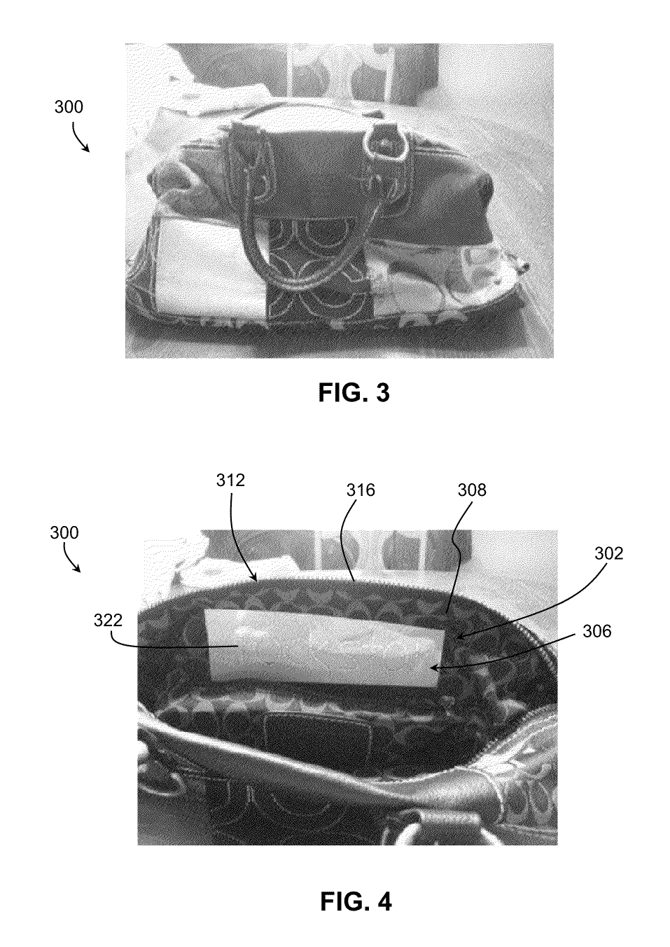

Having generally described the invention above, FIGS. 3 and 4 illustrate an exemplary embodiment of the present invention. The purse 300 shown therein includes a sound/illumination system 302 in accordance with the present invention. While all of the features described and shown in FIGS. 1-2 are not visible in FIGS. 3-4, the purse shown in FIG. 4 may include all such features. As seen in FIG. 4, an illumination module 306 having an array of lights 322 arranged to represent the phrase “Rock Star” affixed to a side wall 308 of an interior compartment 312 of purse 300. When opening 316 of purse 300 is opened, sound/illumination system 302 will operate to light up the phrase “Rock Star” in a certain sequence while sound is being emitted within interior compartment 312 from a sound module (not shown). In effect, purse 300 is customizable and personalized thereby allowing a user to play selected sounds and emit light when the purse 300 is opened and/or accessed by a user.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This aspect is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A sound and illumination system for an enclosure, the enclosure including at least one wall defining an enclosure opening and an interior compartment that is accessible through the enclosure opening, the enclosure opening configured for being selectively placed in an opened position to allow access to the interior compartment and a closed position to restrict access to the interior compartment, the system comprising:
a memory;
a sound module configured for emitting sound upon activation of the sound module, the sound being generated based upon an audio file stored in the memory;
an illumination module configured for emitting light upon activation of the illumination module, the light being emitted based upon a light emission file stored in the memory;
a mounting system configured for attaching the sound module and illumination module with the at least one wall of the enclosure within the interior compartment; and
a switch mechanism configured for selectively activating the sound and illumination modules to emit light and sound within the interior compartment of the enclosure when in the opened position.

2. A system in accordance with claim 1, wherein the illumination module includes an interchangeable array of lights.

3. A system in accordance with claim 1, wherein the memory, the sound module, the illumination module, and the switch mechanism are enclosed within a housing that is configured for being removably attached to the at least one wall of the enclosure within the interior compartment.

4. A system in accordance with claim 3, wherein the housing includes a removable faceplate.

5. A system in accordance with claim 1, further comprising a power source providing power to the sound module and the illumination module.

6. A system in accordance with claim 1, wherein the switch mechanism is at least one of a photovoltaic cell, a touch/heat sensor, motion sensor, or a mechanical switch.

7. A system in accordance with claim 1, further comprising a pivot mechanism for adjusting the position of the sound and illumination modules within the interior compartment.

8. A system in accordance with claim 1, further comprising a communication module configured for allowing at least one of the sound file and the light emission file to be downloaded into the sound and illumination system memory from an external computing device.

9. A system in accordance with claim 8, wherein the external computing device is in communication with the sound and illumination system memory through a network or through synchronization via BLUETOOTH or ZIGBEE.

10. A system in accordance with claim 8, wherein the external computing device is programmed to include a software application configured to access a remote server, download said at least one sound and the light emission file from said server, and store said at least one sound or light emission file in a memory of the external computing device.

11. A system in accordance with claim 1, further comprising a communication module configured for allowing at least one of the sound file and the light emission file to be downloaded into the sound and illumination system memory from a remote server.

12. A system in accordance with claim 1, further comprising a data transfer port configured for allowing at least one of the sound file and the light emission file to be downloaded into the memory from an external computing device.

13. A system in accordance with claim 12, wherein the data transfer port is a USB port.

14. A method of providing sound and illumination within an enclosure, the enclosure including at least one wall defining an enclosure opening and an interior compartment that is accessible through the enclosure opening, the enclosure opening configured for being selectively placed in an opened position to allow access to the interior compartment and a closed position to restrict access to the interior compartment, the method comprising the steps of:
providing a sound module configured for emitting sound upon activation of the sound module;
providing an illumination module configured for emitting light upon activation of the illumination module;
allowing the sound and illumination modules to be coupled to the at least one wall of the enclosure within the interior compartment; and
selectively allowing the sound and illumination modules to emit sound and light within the interior compartment of the enclosure when in the opened position.

15. A method in accordance with claim 14, wherein the sound and light emitted within the interior compartment are synchronized.

16. A method in accordance with claim 14, wherein the sound module and illumination modules are configured for emitting sound and light within the interior compartment when motion is sensed within the interior compartment.

17. A method in accordance with claim 14, further comprising the steps of:
providing a first memory; and
providing a communication module configured for allowing at least one of a sound file and/or a light emission file to be downloaded into the first memory, wherein the sound being emitted is based upon the sound file stored in the first memory and the light being emitted is based upon the light emission file stored in the first memory.

18. A method in accordance with claim 17, wherein an external computing device includes a second memory and a software application stored in the second memory, wherein the software application is configured to access a remote server and download the sound file and/or light emission file from the server and store the sound file and/or light emission file in the second memory.

19. A method in accordance with claim 18, wherein the sound file and/or light emission file is downloaded into the first memory from the external computing device through a wired connection, a wireless network connection, or through synchronization via BLUETOOTH or ZIGBEE.

20. A method in accordance with claim 18, wherein the external computing device is configured for automatically emitting a trigger signal to the communication module upon recognizing a triggering event, wherein the triggering signal is received by the communication module so that the sound module and/or illumination module is activated.

21. A method in accordance with claim 18, wherein the external computing device is configured for emitting a manual trigger signal to the communication module, wherein the manual trigger signal is received by the communication module so that the sound module and/or illumination module is activated.
